(19) United States
(12) Patent Application Publication
(10) Pub. No.: US 2025/0333635 A1
(43) Pub. Date: Oct. 30, 2025

(54) OXIDIZER ENHANCED EMULSIFIED SOLVENT SYSTEMS TO DISSOLVE AND REMOVE TAR

(71) Applicant: Saudi Arabian Oil Company, Dhahran (SA)

(72) Inventors: Mohammed Sayed, Katy, TX (US); Katherine Leigh Hull, Houston, TX (US); Rajesh Kumar Saini, Cypress, TX (US); Brady Kevin Crane, Houston, TX (US)

(21) Appl. No.: 18/647,682

(22) Filed: Apr. 26, 2024

(51) Int. Cl. C09K 8/524; C09K 8/584; E21B 37/06; E21B 43/16

(52) U.S. Cl. CPC C09K 8/524; C09K 8/584; E21B 37/06; E21B 43/16

(57) ABSTRACT

A system and methods for dissolving tar for removal are provided. An exemplary system provides a treatment fluid for dissolving tar for removal. The treatment fluid includes an emulsion of solvent-in-water, and an oxidizer in the water phase. The emulsion can include a surfactant as a stabilizer. The treatment fluid can be used for hydrocarbon recovery from oil sands, or for removing tar deposits from oil reservoirs in sandstone rock or carbonate rock, among others.

### TECHNICAL FIELD

This disclosure relates to methods of dissolving tar deposits in hydrocarbon reservoirs.

### BACKGROUND

Crude oils are complex chemical mixtures, and different crude oils can have substantially different compositions and properties. In addition, reservoir crude oils and organic solids can exhibit complex phase distributions dependent on reservoir fluid geodynamics during and after reservoir charging.

One component often found in crude oil is tar or bitumen. Tar is a complex mixture of high molecular weight compounds, including aromatic hydrocarbons, such as single-ring aromatics and multiple-ring aromatics. Tar is problematic, as it can cause fouling, corrosion, and blocking of reservoirs and downstream equipment.

Since tar is a high molecular weight and high viscosity material, heat can be used to thermally crack the tar into smaller molecular weight compounds that have lower viscosity and increased mobility. Heat can either be provided using the injection of steam or can be provided as a result of the interaction of chemicals that produce heat.

In addition to cracking, steam injection, with or without solvent additive, is an effective method of reducing viscosity of tar or bitumen, for example, by lowering the viscosity through increasing the temperature. However, surface steam generation and injection suffers from various problems including high cost of generation, inefficient heat transfer due to loss to formation rocks, high water requirement, and environmental issues, such as emission of greenhouse gases.

The injection of thermochemical fluids (TCF) for in-situ heat generation for tar mitigation is being proposed. Compared with the conventional method of steam generation through combustion of fuel such as natural gas, downhole heat generation, through exothermic reaction of the TCF, would be more profitable by reducing the cost of steam generation, reduce heat loss, and abate environmental pollution.

Another technique is to use hydrocarbon solvents to extract and dissolve tar. For example, toluene and carbon disulfide have been used to extract and dissolve tar. Other low boiling point solvents have also been used.

Chemical control of the tar deposits relies upon the use of four categories of chemicals. Solvents are generally used to dissolve existing deposits and usually contain a high aromatic content. They dissolve a specific weight of paraffin based upon the molecular weight of the wax, temperature, and pressure before the solvent power is exhausted.

Dispersants do not dissolve paraffin deposits but rather break them up into smaller particle sizes where they can be reabsorbed by, or suspended in, the oil stream. Dispersants may disperse several times their own weight in paraffin but do not have the widespread application of solvents. Generally, given the proper testing techniques a chosen dispersant will prove to be more cost-effective than solvents.

Detergents are a class of surface-active agents, or surfactants, which work in the presence of water to water-wet paraffin particles, formation, tubing, and flowlines. Detergents break up deposits and prevent them from re-agglomerating back together further downstream in the system.

Solvent-based extraction is one of the processes that have been used to extract bitumen from oil sands. In the case of solvent-based extraction, the solvent is the dominant liquid, and the extraction of the bitumen occurs by dissolving bitumen into the solvent. Solvents may have issues related to the low flash point temperatures that impacts the safety of handling these chemicals during transportation and storage.

All of the techniques mentioned here may in some cases be effective to dissolve tar but may suffer many disadvantages. For example, once pumped downhole the fluid when may travel into regions with higher permeability leaving other regions untreated. Thus, the solution or treatment becomes ineffective. Further, dissolved tar may be redeposited as the solvent is diluted with hydrocarbons or crude oil. Therefore, there is a need for a better solution to dissolve and remove tar from a subterranean formation.

### SUMMARY

An embodiment described herein provides a treatment fluid for dissolving tar for removal. The treatment fluid includes an emulsion of solvent-in-water, and an oxidizer in the water phase.

Another embodiment described herein provides a method for dissolving tar for removal. The method includes dissolving an oxidizer into water, forming an emulsion of solvent in the water, injecting the emulsion into a reservoir, and producing dissolved tar from the reservoir.

### BRIEF DESCRIPTION OF DRAWINGS

FIG. 1 is a process flow diagram of a method for using an oxidizing emulsion to remove tar or bitumen from a reservoir.

FIGS. 2A-2D show the preparation of the tar sample and the dissolution tests.

### DETAILED DESCRIPTION

Embodiments described herein provide systems and methods for removing tar from reservoirs. In embodiments described herein, emulsified solvent-in-water and emulsified water-in-solvent formulations are used to dissolve tar deposits. The solvent-in-water emulsions provide improved performance over solvent alone and water-in-solvent emulsions. Further, the solvent-in-water emulsion lowers the flash risk of the treatment, as the solvent is an internal phase in a water external phase emulsion.

In some embodiments, oxidizers are added to the aqueous water phase, forming an oxidizing emulsion that can be used as a treatment fluid, which improves the ability of the treatment fluid to break down the tar deposits. The addition of different oxidizer systems in the water phase in combination with solvents, as an internal phase in the emulsion system, increases the efficiency of the dissolution of the tar.

In various embodiments, the techniques are used in subterranean wells that contain tar, which may block and prevent production. For example, the oxidizing emulsion can be used in an injection well in a reservoir containing tar, for example, when water or stream need to be injected for enhanced oil recovery applications. For example, in embodiments, the technique is used to treat tar organic residue that forms a tar barrier in the reservoir between the water injection well and the oil production well. The treatment can be performed in sandstone reservoirs with a silicon oxides matrix and carbonate reservoirs dominated by limestone, dolomite, or mixture of both. Further, the techniques can be used in unconventional reservoirs dominated by low permeability shale matrix.

In addition to removing tar deposits that damage reservoirs, in some embodiments, the techniques are used for recovering bitumen from mineable deposits, such as oil sands. In these applications, the techniques integrate solvent-based extraction technology and water-based bitumen extraction technology.

As described herein, tar is a dark brown or black viscous material of hydrocarbons and free carbon, obtained from a wide variety of organic materials through destructive distillation. Tar is a mixture of high molecular weight hydrocarbons, such as condensable aromatic and polyaromatic hydrocarbons. Tars have higher molecular weight than benzene with single ring to 5-ring aromatic compounds, other oxygen-containing hydrocarbons, and polycyclic aromatic hydrocarbon (PAH) compounds, including asphaltenes. A similar compound, bitumen, is found in the form of oil-impregnated sand, such as oil sands deposits. Further, some conventional reservoirs, such as in the Middle East and North Africa, accumulate tar or asphaltene, termed “tarmat”.

While deposition of tar and bitumen in reservoirs is a routine occurrence around the world, there is substantial variability in the properties and deposition. For example, the tar or bitumen are at or near the crest of a reservoir, in interlayers within a heterolithic sequence, e.g., baffles, or at the base of the reservoir which can be tens of kilometers away from the crest. Sometimes the deposition is such that the corresponding formation remains permeable. However, in some depositions, the tar zone is totally impermeable.

Further, the concentration of the tar may have significant variation through the reservoir. For example, a tar deposits at the base of the reservoir baby form but by a more or less continuous increase in asphaltenes from the oil immediately above the tar. In some reservoirs, there is a sharp, discontinuous increase in asphaltene content from the oil to the tar. In oil sands reservoirs, the bitumen may be deposited throughout the entire producing interval, while in other oil sands reservoirs, the bitumen deposition is only at the base of the producing interval.

Tar deposits are generally extremely high in viscosity. However, there is a bifurcation in systems that are high in asphaltenes. For example, a single-phase system or crude oil that is high in asphaltene content and, thus, is high in viscosity. High asphaltene materials may also be found in phase separated systems, in which one phase is highly enriched in asphaltene, forming a higher viscosity phase. As used herein, a single-phase system that is high in asphaltene content is termed a tar or bitumen.

The deposition of high discuss viscosity materials, such as tar, can have a significant effect on production. For example, when pore throats are sealed, no further compositional changes within the pore can occur, and crude oil can be trapped within the tar zone. Further, if gas or condensate is added to oil, more than just the asphaltenes can deposit which can give a rheology more like gooey tar than a solid. As a petroleum tar mat can form a pressure seal or a baffle, it can affect aquifer support and water injection in secondary recovery scenarios. Tar mats at the oil-water contact (OWC) can preclude any aquifer support and any effectiveness of water injection in the aquifer. A tar wall in a reservoir between water injection wells and oil production wells can reduce sweep efficiency, and lower recovery. In some circumstances, the tar is formed in the bottom of the well or the well is drilled in the middle of this tar mat. In that case, the tar will hinder the production from the producer well and also hinder injection of water in water injection wells.

Remediation refers to the treatment of geological formations to improve the recovery of hydrocarbons from well damage and arterial blockage caused by the precipitation and deposition of heavy organic molecules, such as tar, from petroleum fluids. Such compounds could separate out of the crude oil solution due to various mechanisms and deposit, causing fouling in the oil reservoir, in the well, in the pipelines and in the oil production and processing facilities. Solid particles suspended in the crude oil may stick to the walls of the conduits and reservoirs reducing oil production from the wells. Well damage caused by the precipitation and deposition of paraffin and asphaltenes have been a recurrent problem in the production of crude oil and can be caused by a number of standard oilfield operations. Such compounds can separate from the crude oil and cause plugging downhole at the bottom of the well or can cause damage within the reservoirs itself. In some cases, these tar deposits form a wall to prevent oil displacement by water injection in secondary recovery process.

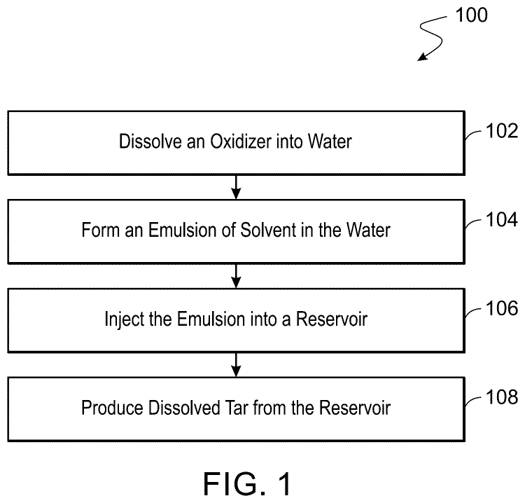

FIG. 1 is a process flow diagram of a method 100 for using an oxidizing emulsion to remove tar or bitumen from a reservoir. The process starts at block 102 when an oxidizer is dissolved into the water. In various embodiments, the oxidizer is a salt of bromate or chlorite. The anion used for the oxidizer can be lithium, sodium, potassium, magnesium, calcium, strontium, or barium, or any combination thereof. For example, the oxidizer salts can include LiClO₃, NaClO₃, KClO₃, Mg(ClO₃)₂, Ca(ClO₃)₂, Sr(ClO₃)₂, Ba(ClO₃)₂, LiBrO₃, NaBrO₃, KBrO₃, Mg(BrO₃)₂, Ca(BrO₃)₂, Sr(BrO₃)₂, Ba(BrO₃)₂. Other oxidizers can be used instead of, or in addition to these, such as hydrogen peroxide, magnesium peroxide, calcium peroxide, t-butylhydroperoxide, sodium nitrate, sodium nitrite, sodium persulfate, potassium persulfate, ammonium persulfate, sodium perborate tetrahydrate, sodium percarbonate, hydrogen peroxide, sodium hypochlorite (bleach), iodate, periodate, dichromate, and permanganate, among others.

The water can be produced water, surface water, seawater, or from other sources. In some embodiments, the water is partially purified to lower ion content before forming the oxidizing emulsion.

At block 104, an oxidizing emulsion of solvent-in-water is formed. The solvent used in the internal phase can be a single solvent system or a mixture of solvents. The solvents can include xylene, toluene, N-methyl pyrrolidone (NMP), ethylene glycol monobutyl ether (EGMBE mutual solvent), acetone, diesel, and kerosene, among others. Xylene, toluene can be used to dissolve polyaromatics and any waxy deposits which are components of tar materials. N-methyl pyrrolidone, ethylene glycol monobutyl ether (EGMBE), and acetone, can be used to dissolve any hydrophilic materials such as oxidized materials having carboxyl OH groups as well as low molecular weight wax.

In various embodiments, a mutual solvent is added to the treatment to improve the wettability properties and allow for better treatment penetration into the reservoir rocks. Mutual solvents are miscible in each other and form solvents with a wide polarity to dissolve matter with different polarity ranges.

The solvent volume fraction in the oxidizing emulsion can be between about 10 volume percent (vol. %) to about 90 vol. % of the oxidizing emulsion, or about 30 vol. % to about 50 vol. % of the oxidizing emulsion. The corresponding water volume fraction can be between about 90 vol. % to about 10 vol. %. In various embodiments, the ratio of the volume fraction of the solvent to the volume fraction of the water can be about 20/80, about 30/70, about 40/60, about 50/50, about 60/40, about 70/30, about 80/20, or at any value in between.

In some embodiments, the addition of other materials, such as an emulsifier, will lower the volume percent of the solvent, the water, or both. The emulsifier can be added to facilitate and stabilize the formation of solvent-in-water emulsion. For the solvent-in-water emulsion, the emulsifier (or surfactant) can be selected from a group with high hydrophobic-lipophobic balance (HLB), for example, greater than 12. Surfactants with high HLB include alkyl ethoxylates with ethylene oxide degree (EO) of more than 7. Examples of these surfactants include Tergitol 15-S-7, Tergitol 15-S-9, Tergitol 15-S-12 from Dow Chemicals, Polysorbate 60, 65, 80 (P80), and sorbitan monooleate, among others. The concentration of the emulsifier can be about 0.1 vol. % to about 5 vol. % of the total treatment volume.

In some embodiments, a chemical dispersant is added to prevent agglomeration of the broken tar molecules when the fluid flow further away from the injector well. For example, the chemical dispersant is another surfactant. Examples of these types of surfactants include Ssucate DOE70, isopropylamine DS and Ceteareth-29, ethoxylated sorbitan monostearate (T-Maz 60K and T-Maz 20), poly (acrylic acid) (PAA), cetrimonium bromide (CTAB) and sodium dodecyl sulfate, Arkopal N-300,Triton X-100, Triton X-102, Triton X-165, and Sapogenat T-300, among others. Additional surfactants can be included to adjust the wettability of rock surfaces in the formation and the miscibility of the broken tar in the hydrocarbon phase. The surfactants may improve the penetration of the treatment into the tar block for better efficiency to break the tar.

The solvent system can be a 100 vol. % of one solvent or a mixture of more than one solvent. The volume fraction of each solvent can be anywhere from 0-100% of the total solvent mixture. This can be determined by which solvent or combination can dissolve the specific tar in the reservoir. Another parameter is the flashpoint temperature of the final mixture.

At block 106, the emulsion is injected into the reservoir. This can be performed through an injection well to remediate tar between the injection well and a production well. In some embodiments, the emulsion can be injected into the reservoir through the injection well to dissolve tar present in the bottom of the injector well. In some embodiments, the emulsion can be injected into the reservoir through the production well, for example, to reduce tar deposits along the production well and in the reservoir near the production well. The reservoir can include oil reservoirs in sandstone rocks or carbonate rocks. In other embodiments, the oxidizing emulsion is injected into an oil sands deposit to mobilize bitumen from an injection well to a production well.

The temperature of the reservoir can be from about 100° F. (38° C.) to about 350° F. (177° C.) and different oxidizers can be used for different temperature ranges in which they are active. For example, sodium persulfate is active at about 140° F. (60° C.) to about 200° F. (93° C.) and sodium bromate is active above 240° F. (116° C.). For the oxidizing emulsion to be functional, it is important to activate the oxidizers.

At block 108, the mobilized tar is produced from the reservoir. For example, this may be in an emulsion with water, or suspended in the hydrocarbons.

### EXAMPLES

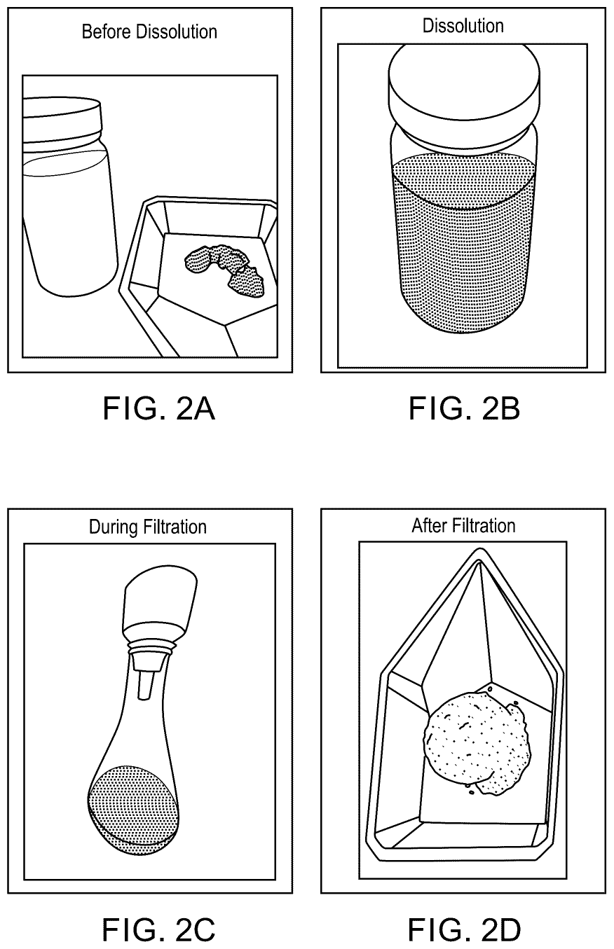

FIGS. 2A-2D show the preparation of the tar sample and the dissolution tests.

Tar Sample Preparation: an asphaltene tar mixture was procured from local home improvement company, as Gardner blacktop drive patch from Home Depot. The asphaltene tar mixture came as an emulsion of water, organic tar, and inorganic mineral particles. The tar material is suspended and kept in dispersion when water or any other solvent is added to the sample. As a result, tar samples were put in oven at 200° F. (93° C.) to remove the water and only keep the organic matter distributed in inorganic minerals (clay, sand, and carbonate), resulting in the material shown in FIG. 2A. After removal of water, the samples were analyzed and found that 70-80 wt. % of the sample is inorganic minerals while the remaining 20 wt. %-30 wt. % is organic matter (tar). The composition of the test material is shown in Table 1.

TABLE 1
Ingredients in commercial tar formulation used for testing.

| Chemical Name | CAS | %(wt) |
|---|---|---|
| Sand (Quartz) | 14808-60-7 | 40% TO 60% |
| Asphalt | 8052-42-4 | 10% TO 20% |
| Bentonite | 1302-78-9 | 1% TO 10% |
| Kaolin | 1332-58-7 | 1% TO 10% |
| Water | 7732-18-5 | 20% TO 30% |

Solvent Systems: Different solvents were selected and tested as a standalone solvent or as a mixture of different solvents for the dissolution of tar. The list of solvents includes xylene, toluene, n-methyl pyrrolidone, ethylene glycol monobutyl ether (EGMBE mutual solvent), acetone, and kerosene. The properties of the solvents are shown in Table 2.

TABLE 2
Solvents used for dissolution tests.

| Solvent | Flashpoint, ° C. |
|---|---|
| Xylene | 32 |
| Toluene | 5 |
| n-methyl pyrrolidone | 86 |
| Ethylene glycol | 71 |
| monobutyl ether | |
| (EGMBE mutual solvent) | |
| Acetone | −18 |
| Kerosene | 50 |

Other chemicals that were used in various solutions included Hyflo-IVM Oil Soluble Surfactant, sodium bromate and sodium chlorite as oxidizers, WS-36M, and AF-70. WS-36M and AF-70 are emulsifying agents for water-external emulsion and oil external emulsion, respectively.
Testing Procedure: Dynamic dissolution testing of dewatered tar samples was performed to test the efficiency of different solvent formulations. The solubility test procedure for all of the chemical formulations was the same. Weigh an empty 100 mL glass bottle and record the weight. Put 3 grams of organic deposit in the glass bottle. Add to the bottle 60 mL of the prepared solvent solution or formulation. Close the bottle and place it in a water bath at ambient temperature for a period of 12 to 18 hours while stirring the whole mixture at a constant speed of 200 rpm. Weigh and label filter papers accordingly before filtering the organic deposit/solvent solution from the bottles. Filter the solution in bottle using the labeled filter paper. Put the labeled filter paper and the glass bottle in the oven at 60° C. and leave them overnight to dry. Measure the weight of each glass bottle and filter paper after drying and record the data. Calculate the organic deposit solubility using the following equation:

$$Solubility \% = ( Original weight ( g ) - Residual weight ( g ) ) * 100 / Original weight ( g )$$

To perform the dynamic dissolution testing, a 3 gram sample of the dried tar/inorganic mixture was weighed. About 60 mL of the solvent solution or formulation was added into the beaker. The tar sample was then added into the beaker and the solution was stirred at a constant speed (of 200 rpm) for 12 to 18 hours.

These experiments were performed at ambient conditions, e.g., atmospheric pressure and room temperature (about 18° C. to about 21° C.). The resulting dissolve solution is shown in FIG. 2B.

After the dissolution was completed, the whole solution in addition to the tar sample was filtered to isolate any remaining solids, as shown in FIG. 2C. The solids were then dried, resulting in the material shown in FIG. 2D, and the dry weight was measured. The amount of tar dissolved was then calculated and the efficiency of the dissolver was evaluated.

Around 60 formulations were prepared and tested to dissolve tar. These formulations included non-emulsified solvent mixtures, solvent mixtures with oxidizers, water with oxidizers, emulsified solvent-in-water with and without oxidizers, and emulsified water-in-solvent with and without oxidizers. A summary table of all the formulations is given in Table 1, below.

TABLE 3
Listing of test fluid mixtures.

| | | | | | | | sodium | sodium | | | | |
|---|---|---|---|---|---|---|---|---|---|---|---|---|
| Fluid | | | | n-methyl | musol | hyflo-IVM | bromate | chlorite | | | WS- | |
| # | xylene | toluene | diesel | pyrrolidone | (EGMBE) | surfactant | 20# | 20# | acetone | Kerosene | 36M | AF-70 |
| 1 | 40 | | 50 | 10 | | | | | | | | |
| 2 | 40 | | 45 | 10 | 5 | | | | | | | |
| 3 | 40 | | 47 | 10 | | 3 | | | | | | |
| 4 | | | 90 | 10 | | | | | | | | |
| 5 | | | 85 | 10 | | 5 | | | | | | |
| 6 | | | 80 | 10 | 5 | 5 | | | | | | |
| 7 | | | | | | | 100 | | | | | |
| 8 | | | | | | | | 100 | | | | |
| 9 | | | | | | | 50 | 50 | | | | |
| 10 | | 40 | 47 | 10 | | 3 | | | | | | |
| 11 | | 40 | 40 | 10 | 5 | 5 | | | | | | |
| 12 | 40 | | 40 | 10 | 5 | 5 | | | | | | |
| 13 | | 30 | 65 | | 5 | | | | | | | |
| 14 | 35 | | 60 | | 5 | | | | | | | |
| 15 | 31 | | 31 | 10 | 5 | 3 | | | | | | |
| 16 | 31 | | 31 | 10 | 3 | 5 | | | | | | |
| 17 | 34 | | 34 | 4 | 5 | 5 | | | | | | |
| 18 | 60 | | 20 | 10 | 5 | 5 | | | | | | |
| 19 | 20 | | 60 | 10 | 5 | 5 | | | | | | |
| 20 | 30 | | 65 | | 5 | | | | | | | |
| 21 | 60 | | 35 | | 5 | | | | | | | |
| 22 | 60 | | 35 | | | 5 | | | | | | |
| 23 | 35 | | 60 | | | 5 | | | | | | |
| 24 | 90 | | 10 | | | | | | | | | |
| 25 | | 10 | | 90 | | | | | | | | |
| 26 | | | | 90 | 10 | | | | | | | |
| 27 | | | | 10 | 90 | | | | | | | |
| 28 | | | | 100 | | | | | | | | |
| 29 | | | 90 | | 10 | | | | | | | |
| 30 | 48 | 48 | | | | 4 | | | | | | |
| 31 | 32 | 64 | | | | 4 | | | | | | |
| 32 | 64 | 32 | | | | 4 | | | | | | |
| 33 | 65 | | 30 | | 5 | | | | | | | |
| 34 | 55 | | 25 | 10 | 5 | 5 | | | | | | |
| 35 | 40 | | 40 | 10 | 5 | 5 | | | | | | |
| 36 | 25 | | 55 | 10 | 5 | 5 | | | | | | |
| 37 | | | 85 | 10 | | 5 | | | | | | |
| 38 | | | 90 | 5 | | 5 | | | | | | |
| 39 | | | | | | | 0.24 g/100 | | | | | |
| | | | | | | | ml water | | | | | |
| 40 | | | | | | | | 0.204 g/100 | | | | |
| | | | | | | | | ml water | | | | |
| 41 | | | | | | | | | 100 | | | |
| 42 | | | | | | | 69 ml of | | | 30 | | 1 |
| | | | | | | | 0.24 g/100 | | | | | |
| | | | | | | | ml water | | | | | |
| 43 | | | | | | | | 69.6 ml of | | 30 | 0.4 | |
| | | | | | | | | 0.24 g/100 | | | | |
| | | | | | | | | ml water | | | | |
| 44 | 27 | | | 3 | | | 69 ml of | | | | 1 | |
| | | | | | | | 0.24 g/100 | | | | | |
| | | | | | | | ml water | | | | | |
| 45 | 27 | | 3 | | | | 69 ml of | | | | | 1 |
| | | | | | | | 0.24 g/100 | | | | | |
| | | | | | | | ml water | | | | | |
| 46 | 27 | | 3 | | | | | 69 ml of | | | 1 | |
| | | | | | | | | 0.24 g/100 | | | | |
| | | | | | | | | ml water | | | | |
| 47 | 27 | | 3 | | | | | 69 ml of | | | | 1 |
| | | | | | | | | 0.24 g/100 | | | | |
| | | | | | | | | ml water | | | | |
| 48 | 60 | | | | | | | | | | | |
| 49 | 100 | | | | | | | | | | | |
| 50 | 100 | | | | | | | | | | | |
| 51 | 100 | | | | | | | | | | | |
| 52 | 85 | | 15 | | | | | | | | | |
| 53 | 95 | | 5 | | | | | | | | | |
| 54 | 90 | | 10 | | | | | | | | | |
| 55 | 27 | | 3 | | | | | | | | | 1 |
| 56 | | 50 | | | | | | 49 ml of | | | 1 | |
| | | | | | | | | 0.24 g/100 | | | | |
| | | | | | | | | ml water | | | | |
| 57 | | 50 | | | | | | | 49 ml of | | 1 | |
| | | | | | | | | | 0.24 g/100 | | | |
| | | | | | | | | | ml water | | | |
| 58 | | 30 | | | | | | 69 ml of | | | 1 | |
| | | | | | | | | 0.24 g/100 | | | | |
| | | | | | | | | ml water | | | | |
| 59 | | 30 | | | | | | | 69 ml of | | 1 | |
| | | | | | | | | | 0.24 g/100 | | | |
| | | | | | | | | | ml water | | | |

The flash point temperature was measured using closed cup technique for all the formulations that are not emulsified. The emulsified solvent-in-water has no flash point as long as the emulsion is not broken. The flash point temperature of the different solvent mixtures was found to range from about 65° F. (18° C.) to about 150° F. (66° C.). Table 4 shows a summary of the flashpoint temperatures.

TABLE 4
Summary of flashpoint temperatures for test fluids.

| Fluid #1 | FP 1 (degF.) | FP2 (degF.) | FP3 (degF.) | FPAVG (degF.) |
|---|---|---|---|---|
| 1 | | | | Around 95 |
| 2 | | | | Around 95 |
| 3 | 94.6 | 94.6 | 94.6 | 94.6 |
| 4 | | | | Above 135 |
| 5 | | | | Above 135 |
| 6 | | | | Above 135 |
| 7 | | | | Aqueous |
| 8 | | | | Aqueous |
| 9 | | | | Aqueous |
| 10 | 60.8 | 68 | 64.4 | 64.4 |
| 11 | | | | Around 65 |
| 12 | | | | Around 100 |
| 13 | 69.5 | 69.5 | 69.5 | 69.5 |
| 14 | | | | Around 100 |
| 15 | | | | Around 100 |
| 16 | | | | Around 100 |
| 17 | | | | Around 100 |
| 18 | | | | Around 100 |
| 19 | | | | Around 100 |
| 20 | 101.9 | 102 | 102 | 102 |
| 21 | | | | Around 100 |
| 22 | 91.2 | 91.2 | 94.8 | 92.4 |
| 23 | 103.8 | 103.8 | 103.8 | 103.8 |
| 24 | | | | Around 100 |
| 25 | | | | Around 130 |
| 26 | | | | Around 130 |
| 27 | | | | Around 150 |
| 28 | | | | Around 150 |
| 29 | | | | Around 130 |
| 30 | 64.2 | 66 | 64.2 | 64.8 |
| 31 | 58.8 | 58.8 | 58.8 | 58.8 |
| 32 | 67.9 | 64.3 | 69.7 | 67.3 |
| 33 | 85.9 | 89.5 | 89.5 | 88.3 |
| 34 | 91.4 | 91.4 | 93.2 | 92 |
| 35 | 96.8 | 96.8 | 93.2 | 95.6 |
| 36 | 105.8 | 104 | 105.8 | 105.2 |
| 37 | 112.6 | 114.5 | 116.3 | 114.5 |
| 38 | 152.6 | 154.4 | 134.6 | 147.2 |
| 48 | 95 | 96.8 | 94.6 | 95.5 |
| 49 | 86 | 82.4 | 78.8 | 82.4 |
| 50 | | | | Around 90 |
| 51 | | | | Around 90 |
| 52 | | | | Around 100 |
| 53 | | | | Around 100 |
| 54 | 86 | 84.2 | 84.2 | 84.8 |
| 55 | | | | Aqueous |
| | | | | (Emulsion) |
| 56 | | | | Aqueous |
| | | | | (Emulsion) |
| 57 | | | | Aqueous |
| | | | | (Emulsion) |
| 58 | | | | Aqueous |
| | | | | (Emulsion) |
| 59 | | | | Aqueous |
| | | | | (Emulsion) |

### Results

As an example of the results, Table 5 shows the dissolution percentage as a function of different non-emulsified mixture of solvents.

TABLE 5
Dissolution percentage as a function of different non-emulsified solvent mixtures.

| Fluid | | | | Mutual | Hyflo- | Initial | Final | |
|---|---|---|---|---|---|---|---|---|
| No. | Xylene | Toluene | Diesel | solvent | ivm | Weight | Weight | Dissolution % |
| 1 | 35 | | 60 | | 5 | 3.05 | 2.59 | 15.08% |
| 2 | 48 | 48 | | | 4 | 3.13 | 4.49 | 20.45% |
| 3 | 64 | 32 | | | 4 | 2.99 | 2.56 | 14.38% |
| 4 | 65 | | 30 | 5 | | 2.99 | 2.36 | 21.07% |

Table 6 shows results for an emulsified solvent-in-water treatment, fluid 6, that contains a 0.24 g/100 mL oxidizer Sodium Bromate.

TABLE 6
Dissolution percentage for oxidizing emulsion.

| Fluid | | n-Methyl | | | Dissolution |
|---|---|---|---|---|---|
| No. | Xylene | pyrrolidone | Oxidizer 1 | AF-70 | % |
| 5 | | | 0.24 g/100 ml | | 0.67% |
| | | | water | | |
| 6 | 27 | 3 | 69 ml of 0.24 | 1 | 26.96% |
| | | | g/100 ml water | | |

Table 7 shows a summary of the dissolution of tar in solvent mixtures as well as emulsified solvent-in-water. The data shows that the dissolution of tar in emulsified formulations containing oxidizer dissolvers is more compared to straight solvent systems.

TABLE 7
Overview of test solutions and dissolution results.

| | Avg | | | | | Hyflo- | sodium | sodium | | | |
|---|---|---|---|---|---|---|---|---|---|---|---|
| | FP, F. | | | | musol | IVM | bromate | chlorite | WS- | AF- | |
| fluid | degF. | xylene | diesel | NMP* | (EGMBE) | surfactant | 20# | 20# | 36M | 70 | dissolution |
| 3 | 95 | 40 | 47 | 10 | | 3 | | | | | 23.30% |
| 20 | 102.0 | 30 | 65 | | 5 | | | | | | 18.85% |
| 23 | 103.8 | 35 | 60 | | | 5 | | | | | 15.08% |
| 36 | 105.2 | 25 | 55 | 10 | 5 | 5 | | | | | 18.86% |
| 37 | 114.5 | | 85 | 10 | | 5 | | | | | 10.79% |
| 38 | 147.2 | | 90 | 5 | | 5 | | | | | 14.70% |
| 44 | Emulsion | 27 | | 3 | | | 69 ml of | | 1 | | 15.77% |
| | | | | | | | 0.24 g/100 | | | | |
| | | | | | | | ml water | | | | |
| 45 | Emulsion | 27 | | 3 | | | 69 ml of | | | 1 | 26.96% |
| | | | | | | | 0.24 g/100 | | | | |
| | | | | | | | ml water | | | | |
| 46 | Emulsion | 27 | | 3 | | | | 69 ml of | 1 | | 20.20% |
| | | | | | | | | 0.24 g/100 | | | |
| | | | | | | | | ml water | | | |
| 47 | Emulsion | 27 | | 3 | | | | 69 ml of | | 1 | 20.38% |
| | | | | | | | | 0.24 g/100 | | | |
| | | | | | | | | ml water | | | |
| 48 | 95.5 | 60 | 35 | | | 5 | | | | | 17.98% |
| 50 | 90 | 100 | | | | | | | | | 16.61% |
| 51 | 90 | 100 | | | | | | | | | 18.21% |
| 52 | 100 | 85 | | 15 | | | | | | | 17.53% |
| 53 | 100 | 95 | | 5 | | | | | | | 17.74% |
| 55 | Emulsion | 27 | | 3 | | | | | | 1 | 19.44% |
| 56 | Emulsion | | 50 | | | | 49 ml of | | 1 | | 16.17% |
| | | | | | | | 0.24 g/100 | | | | |
| | | | | | | | ml water | | | | |
| 57 | Emulsion | | 50 | | | | | 49 ml of | 1 | | 7.84% |
| | | | | | | | | 0.24 g/100 | | | |
| | | | | | | | | ml water | | | |
| 58 | Emulsion | | 30 | | | | 69 ml of | | 1 | | 17.21% |
| | | | | | | | 0.24 g/100 | | | | |
| | | | | | | | ml water | | | | |
| 59 | Emulsion | | 30 | | | | | 69 ml of | 1 | | 17.11% |
| | | | | | | | | 0.24 g/100 | | | |
| | | | | | | | | ml water | | | |

n-methyl pyrrolidone

Table 8 shows all the dissolution percentage data collected for the formulations shown in Table 7.

TABLE 8
dissolution percentage is for formulations in Table 7.

| fluid | initial weight | final weight | dissolution |
|---|---|---|---|
| 3 | 3.09 | 2.37 | 23.30% |
| 10 | 2.98 | 2.39 | 19.80% |
| 13 | 3.12 | 2.36 | 24.36% |
| 20 | 3.13 | 2.54 | 18.85% |
| 22 | 3.03 | 2.09 | 31.02% |
| 23 | 3.05 | 2.59 | 15.08% |
| 30 | 3.13 | 2.49 | 20.45% |
| 31 | 3.01 | 2.41 | 19.93% |
| 32 | 2.99 | 2.56 | 14.38% |
| 33 | 2.99 | 2.36 | 21.07% |
| 34 | 3.14 | 2.54 | 19.11% |
| 35 | 3.14 | 2.53 | 19.43% |
| 36 | 2.97 | 2.41 | 18.86% |
| 37 | 3.15 | 2.81 | 10.79% |
| 38 | 3.13 | 2.67 | 14.70% |
| 39 | 2.99 | 2.97 | 0.67% |
| 40 | 3.16 | 3.15 | 0.32% |
| 41 | 2.97 | 2.59 | |
| 44 | 2.98 | 2.51 | 15.77% |
| 45 | 3.19 | 2.33 | 26.96% |
| 46 | 3.07 | 2.45 | 20.20% |
| 47 | 3.14 | 2.5 | 20.38% |
| 48 | 3.17 | 2.6 | 17.98% |
| 49 | 2.97 | 2.51 | 15.49% |
| 50 | 3.01 | 2.51 | 16.61% |
| 51 | 3.13 | 2.56 | 18.21% |
| 52 | 3.08 | 2.54 | 17.53% |
| 53 | 3.1 | 2.55 | 17.74% |
| 54 | 3.11 | 2.57 | 17.36% |
| 55 | 3.19 | 2.57 | 19.44% |
| 56 | 3.03 | 2.54 | 16.17% |
| 57 | 3.06 | 2.82 | 7.84% |
| 58 | 3.08 | 2.55 | 17.21% |
| 59 | 3.04 | 2.52 | 17.11% |

Use of Emulsified Solvent Treatment Plus Oxidizers: Both water external and oil external emulsions were tested. Each fluid was tested in triplicate. Oxidizer was added into the water aqueous phase in a concentration is 20 ppt (pounds per thousand gallons). It was observed that the addition of the oxidizer had an incremental increase of 3-5% in the dissolution of tar when compared the formulations that did not contain oxidizers. Oxidizer concentration can be increased to higher values to increase the ability to breakdown the long chain hydrocarbons. Temperature is an important factor to activate the oxidizer and it plays an important rule on its efficiency.

### EMBODIMENTS

An embodiment described herein provides a treatment fluid for dissolving tar for removal. The treatment fluid includes an emulsion of solvent-in-water, and an oxidizer in the water phase.

In an aspect, combinable with any other aspect, the solvent includes a single solvent or a mixture of solvents.

In an aspect, combinable with any other aspect, solvent includes xylene, toluene, n-methyl pyrrolidone, ethylene glycol monobutyl ether, acetone, diesel or kerosene, or any combination thereof.

In an aspect, combinable with any other aspect, the solvent includes a mixture of mutual solvents.

In an aspect, combinable with any other aspect, the oxidizer includes a salt of BrO₃⁻, ClO₃⁻, or both. In an aspect, the salt includes lithium, sodium, potassium, magnesium, calcium, strontium, or barium, or any combination thereof.

In an aspect, combinable with any other aspect the oxidizer includes hydrogen peroxide, sodium persulfate. ammonium persulfate, sodium perborate, sodium percarbonate, potassium sulfate, calcium peroxide, magnesium peroxide, t-butyl hydroperoxide, or sodium hypochlorite, or any combination thereof.

In an aspect, combinable with any other aspect, the oxidizer includes sodium persulfate.

In an aspect, combinable with any other aspect, the treatment fluid includes a surfactant. In an aspect, the surfactant has a hydrophobic-lipophilic balance (HLB) of greater than about 12. In an aspect, the surfactant concentration of the total formulation is about 0.1 vol. % to about 5 vol. %.

In an aspect, the oxidizer is active at a temperature of between about 38° C. and about 177° C.

In an aspect, combinable with any other aspect, the oxidizer is active at a temperature of between about 60° C. and about 95° C.

In an aspect, combinable with any other aspect, the oxidizer is active at a temperature of greater than 38° C.

In an aspect, combinable with any other aspect, the oxidizer is active at a temperature of greater than 116° C.

In an aspect, the solvent includes xylene and n-methyl pyrrolidone, the surfactant includes alkyl sorbitan ethoxylates, alkyl alcohol ethoxylates, fatty acid ethoxylate, alkyl aryl sulfonates, or alkyl sulfonates, or any combinations thereof, and the oxidizer includes sodium bromate, sodium chlorite, or a mixture thereof.

Another embodiment described herein provides a method for dissolving tar for removal. The method includes dissolving an oxidizer into water, forming an emulsion of solvent in the water, injecting the emulsion into a reservoir, and producing dissolved tar from the reservoir.

In an aspect, combinable with any other aspect, the method includes selecting the oxidizer based, at least in part, on a reservoir temperature.

In an aspect, a bromate is selected to be the oxidizer.

In an aspect, a persulfate is selected to be the oxidizer.

In an aspect, the method includes selecting xylene, toluene, N-methyl pyrrolidone, ethylene glycol monobutyl ether, acetone, diesel or kerosene, or any combination thereof, as the solvent.

In an aspect, the method includes selecting a mixture of xylene and n-methyl pyrrolidone, a mixture of n-methyl pyrrolidone and ethylene glycol monobutyl ether, or a mixture of diesel and n-methyl pyrrolidone as the solvent.

In an aspect, the method includes adding a chemical dispersant to the emulsion, wherein the chemical dispersant is selected to decrease agglomeration of broken tar molecules.

In an aspect, the method includes injecting the emulsion into an oil sands reservoir.

In an aspect, the method includes injecting the emulsion into a sandstone reservoir containing oil, or a carbonate reservoir containing oil, or a hydraulically fractured shale reservoir.

In an aspect, the method includes producing bitumen from the oil sands reservoir, sandstone reservoirs containing oil, or carbonate reservoirs containing oil.

In an aspect, the method includes injecting the emulsion into a reservoir through an injection well during a secondary or tertiary enhanced oil recovery process.

In an aspect, the method includes producing hydrocarbons and broken tar molecules from the reservoir through a production well.

Other implementations are also within the scope of the following claims.

What is claimed is:

1. A treatment fluid for dissolving tar for removal, comprising:
an emulsion of solvent-in-water; and
an oxidizer in the water phase.

2. The treatment fluid of claim 1, wherein the solvent comprises a single solvent or a mixture of solvents.

3. The treatment fluid of claim 1, wherein the solvent comprises xylene, toluene, n-methyl pyrrolidone, ethylene glycol monobutyl ether, acetone, diesel or kerosene, or any combination thereof.

4. The treatment fluid of claim 1, wherein the solvent comprises a mixture of mutual solvents.

5. The treatment fluid of claim 1, wherein the oxidizer comprises a salt of BrO₃⁻, ClO₃⁻, or both.

6. The treatment fluid of claim 5, wherein the salt comprises lithium, sodium, potassium, magnesium, calcium, strontium, or barium, or any combination thereof.

7. The treatment fluid of claim 1, wherein the oxidizer comprises hydrogen peroxide, sodium persulfate. ammonium persulfate, sodium perborate, sodium percarbonate, potassium sulfate, calcium peroxide, magnesium peroxide, t-butyl hydroperoxide, or sodium hypochlorite, or any combination thereof.

8. The treatment fluid of claim 1, wherein the oxidizer comprises sodium persulfate.

9. The treatment fluid of claim 1, comprising a surfactant.

10. The treatment fluid of claim 9, wherein the surfactant has a hydrophobic-lipophilic balance (HLB) of greater than about 12.

11. The treatment fluid of claim 9, wherein the surfactant comprises about 0.1 vol. % to about 5 vol. %.

12. The treatment fluid of claim 1, wherein the oxidizer is active at a temperature of between about 38° C. and about 177° C.

13. The treatment fluid of claim 1, wherein the oxidizer is active at a temperature of between about 60° C. and about 95° C.

14. The treatment fluid of claim 1, wherein the oxidizer is active at a temperature of greater than 38° C.

15. The treatment fluid of claim 1, wherein the oxidizer is active at a temperature of greater than 116° C.

16. The treatment fluid of claim 9, wherein:
the solvent comprises xylene and n-methyl pyrrolidone;
the surfactant comprises alkyl sorbitan ethoxylates, alkyl alcohol ethoxylates, fatty acid ethoxylate, alkyl aryl sulfonates, or alkyl sulfonates, or any combinations thereof; and
the oxidizer comprises sodium bromate, sodium chlorite, or a mixture thereof.

17. A method for dissolving tar for removal, comprising:
dissolving an oxidizer into water;
forming an emulsion of solvent in the water;
injecting the emulsion into a reservoir; and
producing dissolved tar from the reservoir.

18. The method of claim 17, comprising selecting the oxidizer based, at least in part, on a reservoir temperature.

19. The method of claim 18, comprising selecting a bromate to be the oxidizer.

20. The method of claim 19, comprising selecting a persulfate to be the oxidizer.

21. The method of claim 17, comprising selecting xylene, toluene, N-methyl pyrrolidone, ethylene glycol monobutyl ether, acetone, diesel or kerosene, or any combination thereof, as the solvent.

22. The method of claim 17, comprising selecting a mixture of xylene and n-methyl pyrrolidone, a mixture of n-methyl pyrrolidone and ethylene glycol monobutyl ether, or a mixture of diesel and n-methyl pyrrolidone as the solvent.

23. The method of claim 17, comprising adding a chemical dispersant to the emulsion, wherein the chemical dispersant is selected to decrease agglomeration of broken tar molecules.

24. The method of claim 17, comprising injecting the emulsion into an oil sands reservoir.

25. The method of claim 17, comprising injecting the emulsion into a sandstone reservoir containing oil, or a carbonate reservoir containing oil, or a hydraulically fractured shale reservoir.

26. The method of claim 24, comprising producing bitumen from the oil sands reservoir, sandstone reservoirs containing oil, or carbonate reservoirs containing oil, or a hydraulically fractured shale reservoir.

27. The method of claim 17. comprising injecting the emulsion into a reservoir through an injection well during an enhanced oil recovery process.

28. The method of claim 27. comprising producing hydrocarbons and broken tar molecules from the reservoir through a production well.
